(19) United States
(12) Patent Application Publication
(10) Pub. No.: US 2026/0216813 A1
(43) Pub. Date: Jul. 30, 2026

(54) METHOD FOR JOINING THIN-WALLED WORKPIECES

(71) Applicant: Paul Po CHENG, London (CA)

(72) Inventor: Paul Po CHENG, London (CA)

(21) Appl. No.: 19/457,649

(22) Filed: Jan. 23, 2026

Related U.S. Application Data
(60) Provisional application No. 63/749,037, filed on Jan. 24, 2025.

(51) Int. Cl. B23K 13/01; B23K 101/06; B29C 65/32

(52) U.S. Cl. CPC B23K 13/015; B23K 2101/06; B29C 65/32

(57) ABSTRACT

A system and method for joining thin-walled workpieces.

### CROSS-REFERENCE TO OTHER APPLICATIONS

The disclosure claims priority from U.S. Provisional Application No. 63/749,037 filed Jan. 24, 2025, which is hereby incorporated by reference.

### FIELD

The disclosure is generally directed at connecting workpieces and, more specifically, at a method for joining thin-walled workpieces.

### BACKGROUND

In the prior art, joining thin-walled metal tubes using conventional welding methods is difficult, partly because of “burn through”. Even if “burn through” is avoided, conventional welding results in heat-affected zones in the tubes proximal to the weld, which affects the quality of the weld.

Therefore, there is provided a system and method for joining thin-walled workpieces.

### SUMMARY

For the foregoing reasons, there is a need for a method of joining thin-walled tubes that overcomes or mitigates one or more of the defects or disadvantages of current solutions.

In its broad aspect, the disclosure provides a method of joining first and second thin-walled workpieces. The method includes, first, coaxially positioning the first and second workpieces to locate respective first and second end segments thereof separated by a predetermined gap. One or more heating elements are positioned outside the first and second workpieces, for heating respective first and second heated portions of the first and second end segments to a hot working temperature, at which the first and second heated portions are at least plastically deformable.

The heated portions are covered with an inert atmosphere. Next, the one or more heating element(s) is energized, for heating the first and second heated portions to the hot working temperature.

While the first and second heated portions are at the hot working temperature, one or both of the workpieces are subjected to a translocation motion, to engage the first and second end segments. Also, while the first and second heated portions are at the hot working temperature and engaged with each other, one or both of the workpieces is moved relative to the other, for at least partially subjecting the plastically deformable heated portions to shearing, to join the workpieces together.

In one aspect of the disclosure, there is provided A method of joining first and second thin-walled workpieces, the method including positioning the first and second workpieces to locate respective first and second end segments thereof by a predetermined gap; positioning at least one heating element proximate the first and second workpieces for heating at least one respective first or second heated portions to a hot working temperature, at which the first and second heated portions are at least plastically deformable; energizing said at least one heating element, for heating the at least one respective first or second heated portions to the hot working temperature; while the at least one respective first or second heated portions are at the hot working temperature, subjecting one or both of the workpieces to a translocation motion to engage the first and second workpieces; and while the first and second heated portions are at the hot working temperature and engaged with each other, moving one or both of the first and second workpieces relative to the other, for at least partially subjecting the plastically deformable heated portions to shearing, to join the workpieces together.

In an aspect, the first and second workpieces are coaxially positioned with respect to each other. In a further aspect, the at least one heating element is positioned outside the first and second workpieces. In yet another aspect, the at least one heating element is positioned inside the first and second workpieces. In yet a further aspect, heating the first and second heated portions to the hot working temperature is by induction heating. In another aspect, before heating the first and second heated portions, placing the first and second workpieces in an inert atmosphere.

In yet another aspect, the method includes annealing ends of the workpieces after they have been joined together. In a further aspect, both the first and second heated portions are heated by the heating element. In yet a further aspect, the at least one respective first or second heated portions that is heated by the heating element radiates heat to another of the at least respective first or second heated portions.

### BRIEF DESCRIPTION OF THE DRAWINGS

The disclosure will be better understood with reference to the attached drawings, in which:

FIG. 1A is a cross-section of first and second thin-walled tubes coaxially positioned, and spaced apart from each other, with one or more heating elements positioned outside the tubes.

FIG. 1B is a cross-section of the first and second thin-walled tubes of FIG. 1A, engaged with each other.

FIG. 2 is a cross-section showing the first and second thin-walled tubes of FIGS. 1A and 1B at least partially joined together.

FIG. 3A is a cross-section of first and second thin-walled tubes coaxially positioned and spaced apart from each other, with one or more heating elements positioned inside the tubes.

FIG. 3B is a cross-section of the first and second thin-walled tubes of FIG. 3A, engaged with each other.

FIG. 4 is a cross-section showing the first and second thin-walled tubes of FIGS. 3A and 3B at least partially joined together.

FIG. 5A is a cross-section of a thin-walled tube and a plug coaxially positioned and spaced apart from each other, with one or more heating elements positioned outside the thin-walled tube.

FIG. 5B is a cross-section of the thin-walled tube and the plug of FIG. 5A, at least partially joined together.

FIG. 6A is a cross-section of first and second thin-walled tubes made of different metals coaxially positioned, and spaced apart from each other, with one or more heating elements positioned outside a selected one of the tubes.

FIG. 6B is a cross-section of the first and second thin-walled tubes of FIG. 6A, engaged with each other; and

FIG. 7 is a cross-section showing the thin-walled tubes of FIGS. 6A and 6B at least partially joined together.

### DETAILED DESCRIPTION

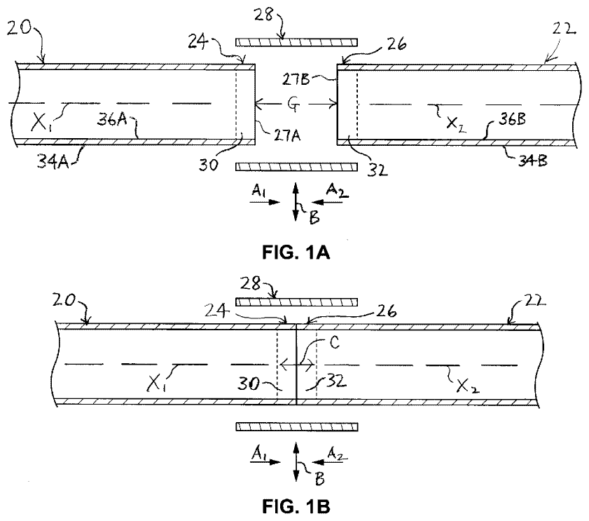

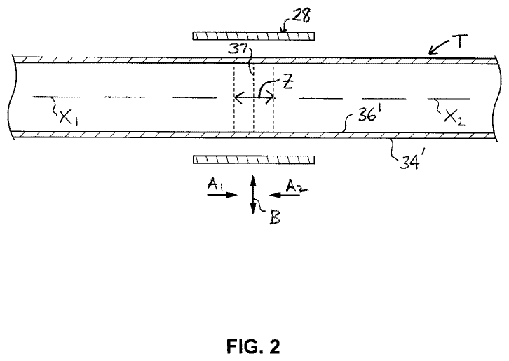

In the attached drawings, like reference numerals designate corresponding elements throughout. Reference is first made to FIGS. 1A-2 to describe an embodiment of a method of joining thin-walled workpieces in accordance with the disclosure.

In one embodiment, the method includes coaxially positioning first and second thin-walled workpieces 20, 22 to locate respective first and second end segments 24, 26 thereof. The end segments 24, 26 are separated by a predetermined gap “G” (FIG. 1A). Respective axes of the workpieces 20, 22 are identified in FIG. 1A by reference characters “X₁”, “X₂”.

In the embodiment illustrated in FIGS. 1A-2, the thin-walled workpieces 20, 22 are tubes. It will be understood that, in other embodiments, the thin-walled workpieces may have any other suitable shape(s) or configuration(s).

The end segments 24, 26 have end surfaces 27A, 27B that are engaged when the workpieces 20, 22 are pushed together (FIG. 1B).

In FIG. 1A, the exterior surfaces of the workpieces 20, 22 are respectively identified by reference characters 34A, 34B and the interior surfaces of the workpieces 20, 22 are respectively identified by reference characters 36A, 36B.

As can be seen in FIG. 1A, one or more heating elements 28 are positioned outside the first and second workpieces 20, 22 for heating respective first and second heated areas of portions 30, 32 of the first and second workpieces 20, 22 thereof to a hot working temperature, at which the respective first and second heated portions 30, 32 of the first and second end segments 24, 26 are at least partially plastically deformable.

It will be understood that the first and second heated portions 30, 32 are enveloped or covered by an inert (non-oxidizing) atmosphere during heating thereof. Those skilled in the art would be aware of a suitable inert atmosphere. Also, as a practical matter, the inert atmosphere may be held in place (i.e., generally positioned over the heated portions 30, 32) by a container (not shown). For clarity of illustration, the inert atmosphere and the container therefor are omitted from the drawings.

Once the inert atmosphere is in place, the one or more heating elements 28 (which in the current embodiment is one) is energized, for heating the first and second heated portions 30, 32 to their hot working temperatures. The hot working temperature is defined as a temperature that is less than the melting temperature of the material that the workpieces are made of. As will be described, where the workpieces are made of different materials, the hot working temperatures for the first 30 and second 32 heated portions may be different.

The heated portions 30, 32 may be heated by the heating element(s) 28 using any suitable method. For example, depending (among other things) on the material of the workpieces, heating may be performed by induction.

While the first and second heated portions 30, 32 are at their hot working temperature or temperatures, one or both of the first and second workpieces 20, 22 are subjected to a translocation motion, urging the end surfaces towards each other, until the end surfaces 27A, 27B are engaged. For instance, when subjected to the translocation motion, one or both of the workpieces 20, 22 may be moved in the directions indicated by arrows “A₁”, “A₂”, respectively, in FIGS. 1A-2. As will be described, the translocation motion may be at a relatively high velocity.

While the first and second heated portions 30, 32 are at their hot working temperature or temperatures and engaged with each other, and while the workpieces 20, 22 are coaxially positioned, one or both of the first and second workpieces 20, 22 are subjected to an engagement motion, to move one or both of the workpieces relative to the other, for at least partially subjecting the plastically deformable heated portions 30, 32 to shear. Such engagement motion may be, for example, radial rotation or oscillation of one or both of the workpieces 20, 22 about their axes “X₁”, “X₂”, as generally indicated by arrow “B”.

In the current embodiment, while the workpieces 20, 22 are engaged and subjected to a radial engagement motion, the workpieces 20, 22 are urged against each other, by a predetermined force such as in an axially directed force.

In some embodiments, the engagement motion may be in a coaxial direction, e.g., a relatively rapid oscillation in the axial direction. Such oscillation is generally indicated by arrow “C” in FIG. 1B. During such oscillation, the workpieces 20, 22 preferably remain engaged. Those skilled in the art would appreciate that during such oscillation, the workpieces may be intermittently urged against each other.

As a result of shearing at least part of the plastically deformable material in the heated portions 30, 32, the workpieces 20, 22 are joined together at their respective end segments 24, 26 to form a unitary product, seen as a tube “T” (FIG. 2).

As noted above, the workpieces 20, 22 are thin-walled, and as a result, the heating element 28, while positioned outside the workpieces 20, 22 and, in some embodiments, parallel to the workpieces, heats the workpieces 20, 22 so that the heated portions 30, 32 in the respective workpieces 20, 22 extend uniformly (or substantially uniformly) between the exterior surfaces 34A, 34B and the interior surfaces 36A, 36B of the workpieces. As the workpieces 20, 22 are thin-walled, the rate of heat transfer in the heated portions 30, 32 is substantially the same therein in all directions.

During the translocation motion, one or both of the workpieces 20, 22 are moved to engage each other at a preselected or predetermined velocity. As will be described, the preselected relative velocity may be selected so that the unitary product or tube “T” has substantially smooth or linear inner and outer diameters along its length.

In one embodiment, given a predetermined revolutions per minute (RPM) for the engagement motion, a higher velocity results in a higher spin for the workpieces and therefore, the engagement RPM is adjusted to suit or match the velocity to reduce the likelihood of the semi-solid nature of some parts of the workpieces going to a liquidus state.

The tube “T” that is formed when the tubes 20, 22 are joined together may have continuous, or substantially continuous, smooth exterior and interior surfaces. In FIG. 2, the exterior and interior surfaces are generally identified by reference characters 34′, 36′ respectively.

Depending on the use or application for the tube “T”, it may be beneficial that one or both of the exterior and interior surfaces 34′, 36′ are smooth, or substantially smooth, along their respective lengths and breadths. For instance, if fluid is to be directed through the completed tube “T”, then a smooth interior surface 36′ is desirable, to minimize or reduce turbulent flow when a liquid passes through the tube “T”. Because the workpieces are thin-walled, however, a substantially smooth interior surface 36′ may require a substantially smooth exterior surface 34′. Accordingly, depending on the use to which the tube “T” is put, in some embodiments, it may be desirable that the interior and exterior surfaces 36′, 34′ are smooth, or substantially smooth.

A generally or substantially smooth exterior and interior surfaces 34′, 36′ is achievable if the preselected velocity is relatively moderate, e.g., approximately 150 to approximate 500 mm/second. Also, it is believed that when the workpieces are urged together, the force applied to do so may be relatively moderate, e.g., approximately 500 N. In other embodiments, the force may be about or less 1 ton/in². Those skilled in the art would appreciate that optimum parameters (i.e., preselected velocity, predetermined force for achieving the desired results of (i) joining the thin-walled workpieces, (ii) with uniformly smooth exterior and interior surfaces 34′, 36′ may be determined via testing. The following are examples of certain optimum parameters, where two stainless steel tubes having a wall thickness of up to 2.2 mm, were processed.

TABLE 1

| | | Urging | Rotation | Push | Rotation |
|---|---|---|---|---|---|
| Gap | Temperature | Force | angle | velocity | speed |
| 1 mm | 1350° C. | 500N | 2-5x | 150 | 200/200 |
| | | | (+/−30°) | mm/second | mm/second |

In the sample data in Table 1, “rotation angle” refers to an engagement motion including a sequence of five partial rotations in which a workpiece is rotated about 30° in a first direction about the axis, and then rotated in the opposite direction about the axis. The sequence of an about 30° rotation at a time may be repeated sequentially about two to about five times.

In the sample date in Table 1, “rotation speed” refers to the speed of rotation of the workpiece about the axis.

In some embodiments, the workpieces 20, 22 may be made of any suitable material such as, but not limited to, steel, stainless steel, additive and/or aluminum. As discussed above, as the workpieces 20, 22 are thin-walled, the heated portions 30, 32 are uniformly heated, at a uniform rate. In general, a workpiece may be considered thin-walled if it can be uniformly heated, or substantially uniformly heated throughout the heated portions thereof in a relatively short time period. As an example, the tube wall may be about 1 to about 2.2 mm (approximately 0.039 to approximately 0.087 inch thick).

When the heated portions 30, 32 are subjected to shear, the material that is sheared defines a zone “Z” that includes at least some of the heated portions 30, 32 (FIG. 2). As a result of the plastically deformable material being sheared, the material in the zone “Z” recrystallizes. The recrystallized material preferably has a substantially uniform microstructure. The end surfaces 27A, 27B of the end portions 24, 26 are at least partially subsumed in the zone “Z” of recrystallized material. In FIG. 2, the region in which the tubes 20, 22 are joined together, and the end surfaces 27A, 27B are subsumed, is identified by reference character 37.

It will be understood that the zone “Z” is typically very small, e.g., the zone “Z” may include only the first several atomic layers of the workpieces 20, 22 at the end surfaces 27A, 27B, however, the size or width of the zone “Z” as illustrated in FIG. 2 is exaggerated, for clarity of illustration.

It will also be understood that the heating element 28 may be positioned outside the tubes 20, 22 when, in the circumstances, it is convenient to do so. Where the heating element is elongate, the heating element may be positioned parallel (or substantially parallel, as the case may be) to the axes “X₁”, “X₂”.

Because the heating element is not between the workpieces, the heating element may continue to heat the heated portions for some time after the heated portions are at their hot working temperature or hot working temperatures, and while the end surfaces 27A, 27B are engaged and one or more of the workpieces are moved relative to the other workpiece, i.e., while one or both of the workpieces are subject to the engagement motion. Maintaining the heat from the heating element for a prolonged time period while one or both of the workpieces are subjected to the engagement motion allows more time in which the heated portions may be subjected to shearing. By controlling the heat input of the heating element, the weld region between the end surfaces 27A, 27B may experience or undergo post-weld grain refinement (annealing) immediately or shortly after joining. One advantage of the current disclosure is that there is “immediate” temperature control during and immediately after contact.

Because the heating elements may remain in position after the workpieces are joined, the heating elements may also be utilized for heat treatment of the workpieces or parts thereof, e.g., annealing, after the workpieces are joined together.

An advantage of the disclosure is that the temperature of the heated portion may be controlled to be from directly below a melting temperature to a desired annealing temperature, in a time and speed sequence under exact conditions. Annealing between similar materials or dissimilar materials improves the bonding characteristics between the two materials.

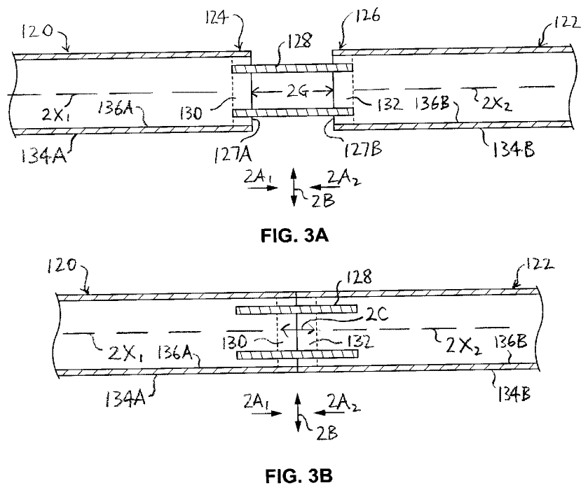

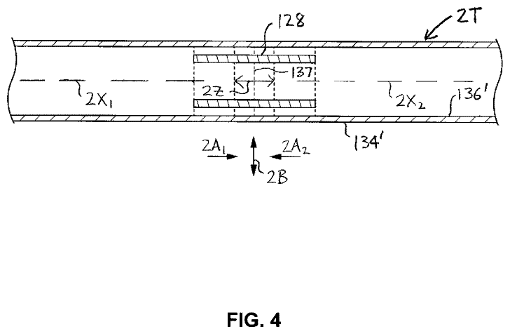

In some circumstances, it may be more convenient to position the one or more heating elements inside the workpieces. An embodiment of the method of the disclosure in which the heating element or heating elements are positioned inside the workpieces is illustrated in FIGS. 3A-4.

In one embodiment, the method includes coaxially positioning first and second thin-walled workpieces 120, 122 to locate respective first and second end segments 124, 126 thereof. The end segments 124, 126 are separated by a predetermined gap “2G” (FIG. 3A). The respective axes of the tubes 120, 122 are identified in FIG. 3A by reference characters “2X₁” and “2X₂”.

The end segments 124, 126 have end surfaces 127A, 127B that are engaged when the tubes 120, 122 are pushed together (FIG. 3B).

As can be seen in FIG. 3A, one or more heating elements 128 (in the current embodiment, one) are positioned inside the first and second workpieces 120, 122 for heating respective first and second areas or heated portions 130, 132 to a hot working temperature, at which the respective heated portions 130, 132 of the first and second end segments 124, 126 are at least partially plastically deformable. In some embodiments, the heating element 28 is circular whereby a single heating element may be able to heat the heated portions 130, 132 of the first and second end segments 124, 126.

It will be understood that the heated portions 130, 132 are enveloped or covered by an inert (non-oxidizing) atmosphere during heating thereof. As a practical matter, the inert atmosphere may be held in place (i.e., generally over the heated portions 130, 132) by a container (not shown). It will also be understood that the inert atmosphere and the container therefor are omitted from the drawings for clarity of illustration.

Once the inert atmosphere is in place, the heating element 128 is energized, for heating the heated portions 130, 132 to their hot working temperature or temperatures (depending if the workpieces are made of the same or different materials. As discussed above, the hot working temperature may be seen as a temperature that is less than the melting temperature of the material that a tube is or the tubes are made of.

While the heated portions 130, 132 of the first and second end portions or segments 124, 126 are at their hot working temperature, one or both of the first and second workpieces 120, 122 are subjected to a translocation motion until the surfaces 127A, 127B are engaged. For instance, when subjected to the translocation motion, one or both of the workpieces 120, 122 may be urged in the directions indicated by arrows “2A₁”, “2A₂” in FIG. 3A.

While the heated portions 130, 132 are at their hot working temperature or temperatures and engaged with each other, and while the workpieces 120, 122 are coaxially located, one or both of the first and second workpieces 120, 122 are subjected to an engagement motion to move relative to the other workpiece, for at least partially subjecting the plastically deformable heated portions 130, 132 to shear. Such movement may be, for example, radial rotation or oscillation of one or both of the tubes 120, 122 about the axes “2X₁” or “2X₂”, as the case may be, as generally indicated by arrow “2B”.

While the workpieces 120, 122 are engaged and subjected to a radial engagement motion, the workpieces 120, 122 are urged against each other, by a predetermined force. In some embodiments, the predetermined force is axially directed.

In one embodiment, the engagement motion may be in a coaxial direction, e.g., a relatively rapid oscillation in the axial direction. Such oscillation is generally indicated by arrow “2C” in FIG. 3B. During such oscillation, the workpieces 120, 122 preferably remain engaged. During such oscillation, the workpieces are only intermittently urged against each other.

As a result of shearing at least part of the plastically deformable material, the workpieces 120, 122 are joined together at their respective end segments 124, 126 to form a tube “2T” (FIG. 4).

In FIG. 3A, the exterior surfaces of the workpieces 120, 122 are identified by reference characters 134A, 134B respectively, and the interior surfaces of the workpieces are identified by reference characters 136A, 136B respectively. As noted above, the workpieces 120, 122 are thin-walled, and as a result, the heating element 128, while positioned inside the workpieces 120, 122 and parallel to the workpieces, may heat the workpieces 120, 122 so that the heated portions 130, 132 extend from exterior surfaces to interior surfaces of the workpieces.

The workpieces may be made of any suitable material such as, but not limited to, steel, stainless steel, additive, and/or aluminum. Because the workpieces 120, 122 are thin-walled, the heated portions 130, 132 are uniformly heated. In general, a workpiece may be considered thin-walled if it can be uniformly heated, throughout the heated portions thereof over a relatively short time period.

While different heating methods are contemplated, in some embodiments, the heating element 128 is configured to heat the heated portions 130, 132 via induction heating.

When the heated portions are subjected to shear, the material in a zone “2Z” including at least some of the heated portions recrystallizes on cooling whereby the recrystallized material preferably has a substantially uniform microstructure. The end surfaces 127A, 127B of the end segments 124, 126 are at least partially subsumed in the zone “2Z” of recrystallized material. In FIG. 4, the region in which the workpieces 120, 122 are joined together is identified by reference character 137.

It will be understood that the zone “2Z” is very small, e.g., the zone “2Z” may include only the first several atomic layers of the workpieces 120, 122 at the end surfaces 127A, 127B. In FIG. 4, the width of the zone “2Z” is exaggerated, for clarity of illustration.

The tube “2T” that is formed when the tubes 120, 122 are joined together preferably has continuous, or substantially continuous, smooth exterior and interior surfaces. In FIG. 4, the exterior and interior surfaces are generally identified by reference characters 134′, 136′ respectively for convenience.

It will be understood that the heating element 128 may be positioned inside the workpieces 120, 122 when, in the circumstances, it is convenient to do so. Where the heating element is elongate, in some embodiments, the heating element is positioned parallel (or substantially parallel, as the case may be) to the axes “2X₁”, “2X₂”.

From the foregoing, it will be understood that, in an alternative embodiment, the heating elements may be positioned both inside and outside the workpieces.

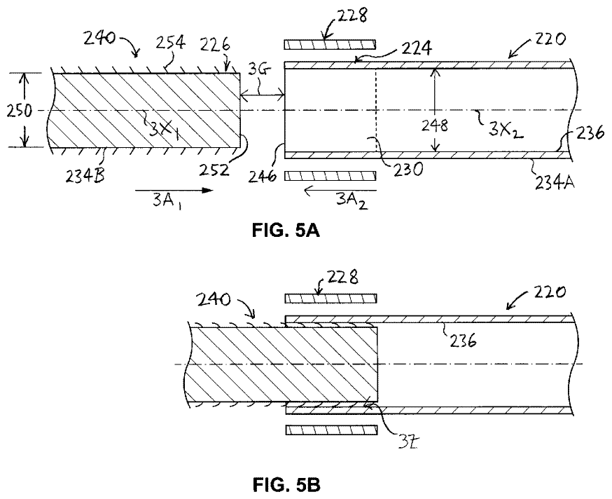

In another embodiment, as shown in FIG. 5A, a thin-walled tube 220 and a plug 240 are coaxially positioned with a gap “3G” defined therebetween. The tube 220 and the plug 240 have respective axes “3X₁”, “3X₂”. As shown, the tube 220 includes an end segment 224 extending from an end 246 of the tube 220.

As can be seen in FIG. 5A, the tube 220 includes an interior surface 236 that defines an inner diameter 248 of the tube 220 and an exterior surface 234A opposite to the interior surface 236 thereof.

In the current embodiment, the plug 240 has an exterior surface 234B defining an outer diameter 250 of the plug 240. It will be understood that the outer diameter 250 is only slightly smaller than the inner diameter 248 of the tube 220.

As can be seen in FIG. 5A, the plug 240 has an end segment 226 extending from an end 252 thereof. As will be described, the end segment 226 of the tube 240 fits into the end portion 224 of the tube 220. It will be understood that only a light pressure is needed to push the end segment in a light drive fit.

One or more heating elements 228 are positioned outside the tube 220, proximal to the end segment 224, for heating an area or heated portion 230 of the end segment 224 to a hot working temperature, at which the heated portion 230 is plastically deformable. In some embodiments, the heating element is circular and surrounds the outside of the tube 220.

As noted above, while the heated portion 230 is heated, the heated portion 230 is covered by an inert atmosphere.

In one embodiment, the plug 240 includes a number of fins 254 mounted on the exterior surface 234B of the plug 240 in the end segment 226. It will be understood that, as illustrated in FIG. 5A, the lengths of the fins 254 are exaggerated for clarity of illustration, and the spacing between the fins 254 is also exaggerated, for clarity of illustration.

The heating element 228 is then energized to heat the heated portion 230. As the tube 220 is thin-walled, the heated portion 230 is uniformly, or substantially uniformly, heated to its hot working temperature. While the heated portion 230 is at the hot working temperature, one or both of the tube 220 and the plug 240 are subjected to a translocation motion, as indicated by arrows “3A₁”, “3A₂”, to position the end segment 226 of the plug 240 in the end segment 224 of the tube 220. As the end segment 226 of the plug 240 and/or the end segment 224 of the tube 220 move relative to the other, the fins 254 preferably engage the interior surface 236 of the tube 220, while the end segment 226 is positioned in or within the end segment 224 of the tube 220.

As the end segment 226 is positioned inside the heated portion 230 of the tube 220, the fins 254 engage the interior surface 236. At the heated portion 230, the interior surface 236 is at the hot working temperature. It will be understood that when the fins 254 engage the interior surface 236 at the heated portion 230, heat energy is conducted into the fins 254 accordingly. Because the fins 254 are relatively thin, they are quickly heated to their hot working temperature, and the fins 254 and the heated portion 230 are at least partially plastically deformed by an engagement motion.

In some specific embodiments, the at least one heating element is placed against the component (the tube 220 or the plug 240) that has a higher melting temperature. For example, between steel and aluminum, the heating element, which may be a heating coil, will be placed against the component that is made of steel. In another embodiment between copper and aluminum, the heating element is placed against the component that is made from copper. This allows heat transfer from the high temperature melting material to the lower temperature melting material. The heating element may remain active as the ends of the components are sheared.

The tube 220 and/or the plug 240 may then be subjected to an engagement motion while they are also subjected to the translocation motion. As noted above, the engagement motion may be any motion of one element (the plug or the tube) relative to another. In some embodiments, the elements (the plug and the tube) may both be subjected to engagement motion(s) at the same time.

Because the fins 254 are engaged with the hot interior surface 236 while the tube 220 and/or the plug 240 are subjected to the engagement motion, the fins 254 and at least part of the heated portion 230 proximal to the interior surface 236 are subjected to shear, during the engagement motion. As a result, a zone “3Z” of sheared material is formed, bonding the end segments 224, 226 together. The microstructure of the sheared material in the zone “3Z” is generally uniform.

It will be understood that the zone “3Z” is very small, e.g., the zone “3Z” may include only the first several atomic layers of the tube 220 and the plug 240 at the interior surface 236 and at the fins 254 respectively. The fins 254 and the interior surface 236 are subsumed into the zone “3Z” of bonded metal, due to the engagement motion.

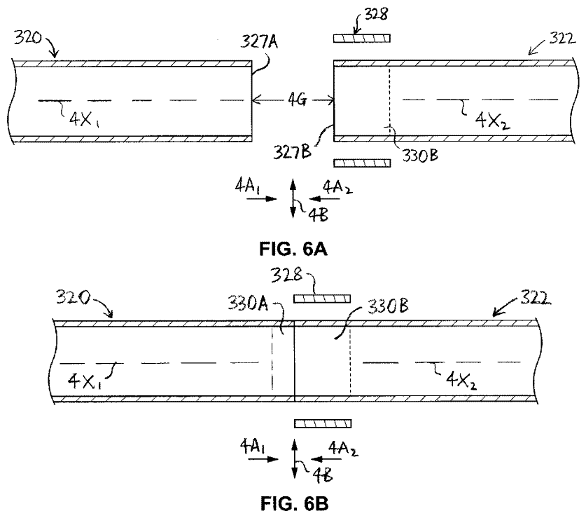

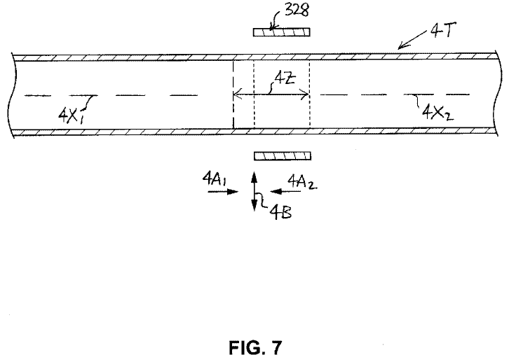

In another embodiment, illustrated in FIGS. 6A-7, a first tube 320 is made of a first metal, and a second tube 322 is made of a second metal where the first and second metal are different metals. In one example embodiment, the first metal has a melting temperature that is lower than the second metal's melting temperature. For instance, the first tube 320 may be made of aluminium, or a suitable aluminium alloy having a melting temperature of approximately 660° C. or less, and the second tube 322 may be made of steel having a melting temperature of approximately 1,350° C.

As can be seen in FIG. 6A, initially, the tubes 320, 322 are coaxially positioned and spaced apart by a gap “4G”. Respective axes of the tubes 320, 322 are defined as “4X₁”, “4X₂”.

One or more heating elements 328 are positioned outside the second tube 322 (FIG. 6A). The heating element 328 is positioned to heat only a heated portion 330B of the tube 322 to a hot working temperature.

Once the heated portion 330B is covered by an inert atmosphere, the heating element 328 is energized to heat the heated portion 330B such as via induction heating.

While the heated portion 330B is at its hot working temperature, one or both of the tubes 320, 322 are subjected to a translocation motion, to cause the tubes 320, 322 to engage each other, end-to-end. The translocation motion may be in the directions indicated by arrows “4A₁” or “4A₂”, or in both directions. When the tubes 320, 322 are so engaged, an end surface 327A of the first tube 320 is preferably urged against the end surface 327B of the second tube 322.

Because the tube 320 has not been heated via induction heating, heat energy is transferred from the heated portion 330B to a heated portion 330A by conduction when the end surfaces 327A, 327B are engaged (FIG. 6B). In some embodiments, the heating element may remain heated to improve heat transfer from the heating portion 330B to the heated portion 330A.

For example, if the second tube 322 is made of steel, then the heated portion 330B may be at a hot working temperature that is approximately 800° C., when the end surfaces 327A, 327B are engaged. It will be understood that, upon engagement, sufficient heat energy is transferred to the heated portion 330A by conduction to heat the heated portion 330A to the hot working temperature of the metal of the first tube 320. In some embodiments, the first tube 320 can be placed closer to the second tube 322 to absorb radiated heat, so upon contact between the ends of the tubes, the heat differential can be closer to an optimum or preferred temperature instead of depending on direct heat transfer upon contact.

As will be described, this is possible because of the significant difference between the melting temperatures of the respective metals. Due to such difference, the hot working temperature of the metal in the first tube 320 is far lower than the hot working temperature of the metal in the second tube 322.

Upon engagement of the end surfaces 327A, 327B, one or both of the tubes are subjected to an engagement motion, in which one or both of the tubes is moved relative to the other. Such movement may be rotation or oscillation about the axes “4X₁”, “4X₂”, as indicated by arrow “4B”.

Alternatively, such engagement motion may involve axial movement, combined with movement about one of the axes, during which the tubes remain engaged.

Because the heated portions 330A, 330B are engaged with each other while the tube 320 and/or the tube 322 are subjected to the engagement motion, the heated portions 330A, 330B are at least partially subjected to shear, during the engagement motion. As a result, a zone “4Z” of sheared material is formed, bonding the tubes 320, 322 together, to form a tube “4T” (FIG. 7). It will be understood that the microstructure of the sheared material in the zone “4Z” is generally uniform. The end surfaces 327A, 327B are subsumed into the zone “4Z” of bonded metal, due to the engagement motion.

It will be understood that the zone “4Z” is very small, e.g., the zone “4Z” may include only the first several atomic layers of the workpieces 320, 322 at the end surfaces 327A, 327B. The width of the zone “4Z” as illustrated in FIG. 7 is exaggerated, for clarity of illustration.

It will be appreciated by those skilled in the art that the invention can take many forms, and that such forms are within the scope of the invention as claimed. The scope of the claims should not be limited by the preferred embodiments set forth in the examples but should be given the broadest interpretation consistent with the description as a whole.

I claim:

1. A method of joining first and second thin-walled workpieces, the method comprising:
(a) positioning the first and second workpieces to locate respective first and second end segments thereof by a predetermined gap;
(b) positioning at least one heating element proximate the first and second workpieces for heating at least one respective first or second heated portions to a hot working temperature, at which the first and second heated portions are at least plastically deformable;
(c) energizing said at least one heating element, for heating the at least one respective first or second heated portions to the hot working temperature;
(d) while the at least one respective first or second heated portions are at the hot working temperature, subjecting one or both of the workpieces to a translocation motion to engage the first and second workpieces; and
(e) while the first and second heated portions are at the hot working temperature and engaged with each other, moving one or both of the first and second workpieces relative to the other, for at least partially subjecting the plastically deformable heated portions to shearing, to join the workpieces together.

2. The method of claim 1 wherein the first and second workpieces are coaxially positione3d with respect to each other.

3. The method of claim 1 wherein the at least one heating element is positioned outside the first and second workpieces.

4. The method of claim 1 wherein the at least one heating element is positioned inside the first and second workpieces.

5. The method of claim 1 wherein heating the first and second heated portions to the hot working temperature is by induction heating.

6. The method of claim 1 further comprising, before heating the first and second heated portions:
placing the first and second workpieces in an inert atmosphere.

7. The method of claim 1 further comprising:
annealing ends of the workpieces after they have been joined together.

8. The method of claim 1 wherein both the first and second heated portions are heated by the heating element.

9. The method of claim 1 wherein the at least one respective first or second heated portions that is heated by the heating element radiates heat to another of the at least respective first or second heated portions.
